(19) United States
(12) Patent Application Publication
(10) Pub. No.: US 2025/0132798 A1
(43) Pub. Date: Apr. 24, 2025

(54) CONFIGURABLE ANTENNA RESOURCES FOR BACKHAUL AND ACCESS WITH UNIFORM CIRCULAR ARRAY PANEL

(71) Applicant: QUALCOMM Incorporated, San Diego, CA (US)

(72) Inventors: Min HUANG, Beijing (CN); Wanshi CHEN, San Diego, CA (US); Hao XU, Beijing (CN); Peter GAAL, San Diego, CA (US); Chao WEI, Beijing (CN); Danlu ZHANG, San Diego, CA (US)

(21) Appl. No.: 18/695,719

(22) PCT Filed: Nov. 23, 2021
(86) PCT No.: PCT/CN2021/132324

§ 371 Date: Mar. 26, 2024

(51) Int. Cl. H04B 7/06; H04W 84/04

(52) U.S. Cl. CPC H04B 7/0617; H04B 7/0626; H04W 84/047

(57) ABSTRACT

Aspects of the present disclosure relate to wireless communications, and more particularly, to techniques for techniques for wireless communications based on orbital angular momentum (OAM) modes. One aspect provides a method for wireless communications by a first wireless node. The method generally includes transmitting traffic to a user equipment (UE) on an access link, using a first portion of a uniform circular array (UCA) antenna panel and transmitting traffic to a second wireless node on a backhaul link, using a second portion of the UCA antenna panel.

### INTRODUCTION

Aspects of the present disclosure relate to wireless communications, and more particularly, to techniques for communications using configurable antenna resources for backhaul and access with uniform circular array (UCA) panels.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect of the present disclosure provides a method for wireless communication by a first wireless node. The method generally includes transmitting traffic to a user equipment (UE) on an access link, using a first portion of a uniform circular array (UCA) antenna panel and transmitting traffic to a second wireless node on a backhaul link, using a second portion of the UCA antenna panel.

One aspect provides a method for wireless communication by a second wireless node. The method generally includes receiving, from a first wireless node, an indication of a configuration of a first portion of a uniform circular array (UCA) antenna panel to use for communication with the first wireless node on a backhaul link and receiving traffic from the first wireless node on the backhaul link, using the first portion of the UCA antenna panel.

One aspect provides a method for wireless communication by a user equipment (UE). The method generally includes receiving, from a wireless node, a configuration of antenna resources for each of a plurality of channel state information reference signals (CSI-RS) resources or ports, estimating a non-beamformed channel matrix based on non-beamformed CSI-RS transmitted according to the configuration, and reporting a beamforming weight vector to the wireless node based on the estimation.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example base station and user equipment.

FIGS. 3A-3D depict various example aspects of data structures for a wireless communication network.

FIG. 4 illustrates an example of an orbital angular momentum (OAM) based communication system, in accordance with certain aspects of the present disclosure.

FIG. 5A and FIG. 5B illustrate characteristics of an OAM based communication system, in accordance with certain aspects of the present disclosure.

FIG. 6A and FIG. 6B illustrate characteristics of an OAM based communication system using uniform circular array (UCA) transmitter antennas and a set of UCA receiver antennas, in accordance with certain aspects of the present disclosure.

FIG. 7 illustrates an example wireless communication system, in which aspects of the present disclosure may be practiced.

FIG. 8 illustrates how different portions of a UCA panel may be used for backhaul and access traffic.

FIG. 9A and FIG. 9B illustrate how different portions of a UCA panel may be reconfigured to adjust for changes in backhaul and access traffic, in accordance with certain aspects of the present disclosure.

FIG. 10 illustrates how different portions of a UCA panel may be used for backhaul and access traffic, in accordance with certain aspects of the present disclosure.

FIG. 11 illustrates features of an example UCA based transmitter, in accordance with certain aspects of the present disclosure.

FIG. 12A, FIG. 12B, and FIG. 12C illustrate different configurations of UCA antenna rings, in accordance with certain aspects of the present disclosure.

FIG. 13A, FIG. 13B, and FIG. 13C illustrate different configurations of UCA antenna rings, in accordance with certain aspects of the present disclosure.

FIG. 14 illustrates example operations for wireless communication by a transmitter, in accordance with certain aspects of the present disclosure.

FIG. 15 illustrates example operations for wireless communication by a receiver, in accordance with certain aspects of the present disclosure.

FIGS. 16-17 depict devices with example components capable of performing techniques performed herein.

### DETAILED DESCRIPTION

Aspects of the present disclosure provide apparatuses, methods, processing systems, and computer-readable mediums for wireless communications using configurable antenna resources for backhaul and access with a uniform circular array (UCA) panel.

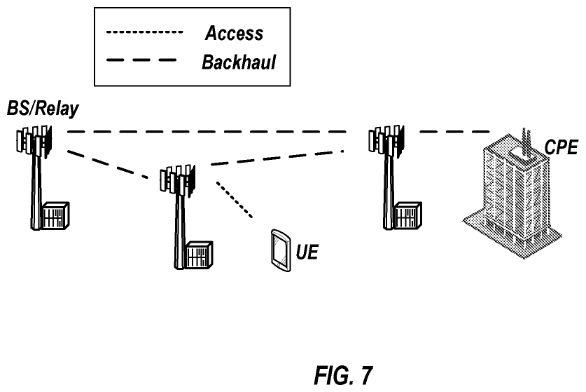

Advanced Networks (5G+, 6G), such as the example network 700 shown in FIG. 7, may rely on integrated access and backhaul (IAB) nodes to help meet demanding data requirements. As illustrated, IAB nodes may be densely deployed to provide more backhaul support between network entities, such as other IAB nodes and customer premise equipment CPE), as well as access support to user equipments (UEs).

In some cases, an IAB node may use orbital angular momentum (OAM) based communications using a multi-ring using uniform circular array (UCA) panel to transmit backhaul traffic. In such cases, the IAB node typically only uses outer antenna rings with large radiuses for backhaul traffic. This is because antenna rings with larger radius can support more multiplexed OAM modes and, thus, higher throughput.

To improve the hardware utilization ratio and reduce deployment cost, the inner antenna rings in UCA can be used to transmit access traffic. Because a UE does not often lie in the boresight direction of network entity (e.g., gNB/IAB node) UCA panel, non-OAM beams may be used for the access link. In practice, the traffic demands of backhaul and access may change at different time periods. For example, when some UE moves from the cell of a parent IAB node to the cell of a child IAB node, the backhaul traffic of the parent IAB node (between the parent and child IAB nodes) may increase, while its access traffic decreases.

Aspects of the present disclosure provide mechanisms that may help address such changing backhaul and access needs. For example, such mechanisms may allow for the configuration and reconfiguration of UCA antenna resources divided between backhaul and access traffic. When needed, more antenna rings can be configured to realize higher spatial multiplex degree and beamforming gain.

The techniques presented herein may be applied in various bands utilized for NR (5G) and future systems (e.g., 5G+, 6G, and beyond). OAM communication tends to perform well in short/middle-distance wireless communication (backhaul/access), especially at high frequency spectrum (e.g., sub-THz, THz).

### Introduction to Wireless Communication Networks

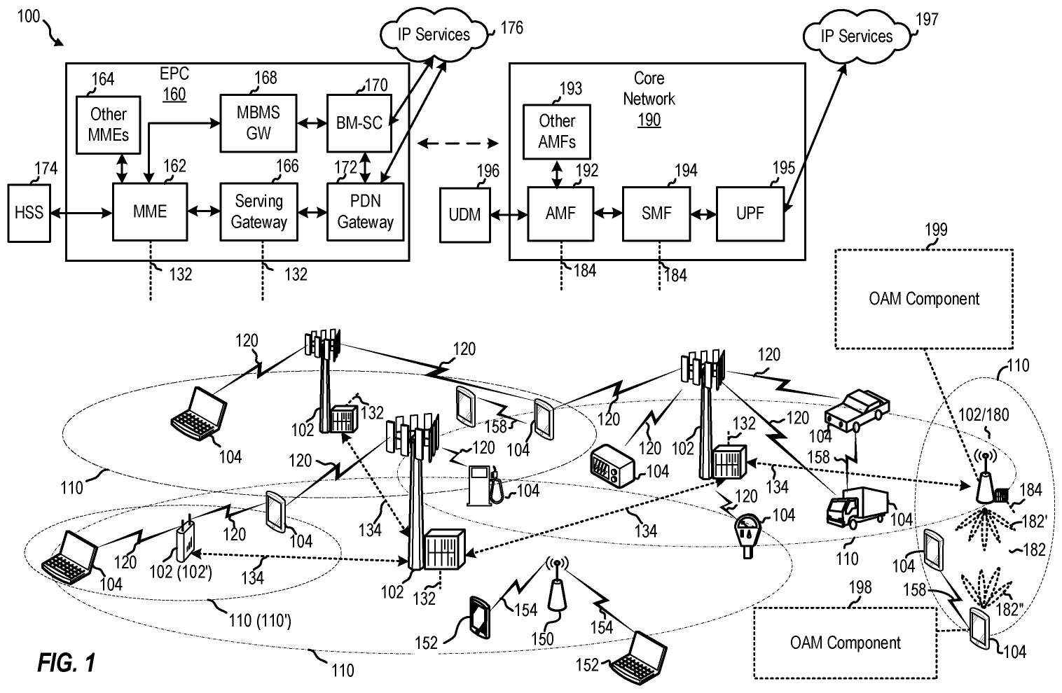

FIG. 1 depicts an example of a wireless communications system 100, in which aspects described herein may be implemented.

Generally, wireless communications system 100 includes base stations (BSs) 102 (which may also be referred to herein as access node (AN) 102), user equipments (UEs) 104, an Evolved Packet Core (EPC) 160, and core network 190 (e.g., a 5G Core (5GC)), which interoperate to provide wireless communications services.

Base stations 102 may provide an access point to the EPC 160 and/or core network 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, Node B, eNB, an access point, a base transceiver station, a radio base station, a radio transceiver, or a transceiver function, or a transmit reception point (TRP) in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

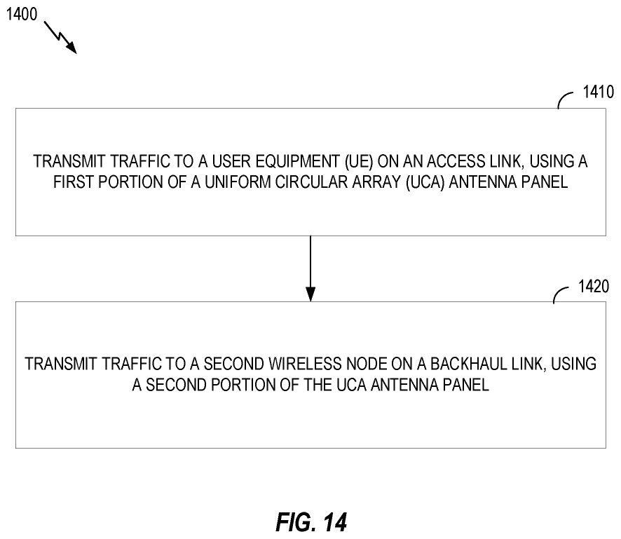

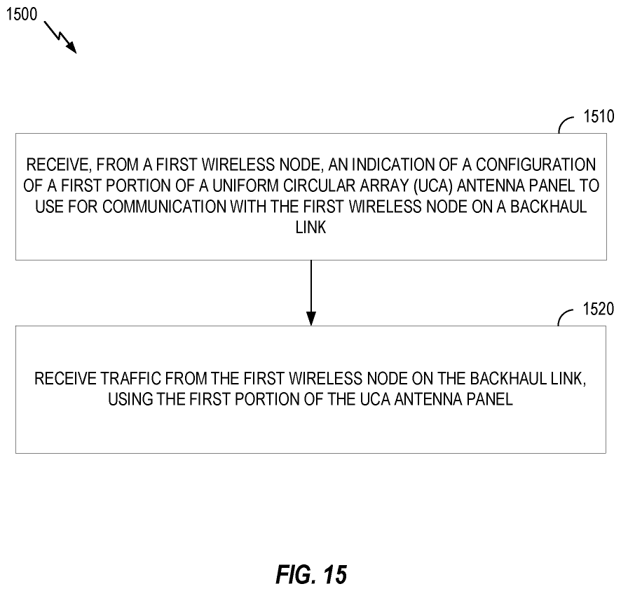

Wireless communication network 100 includes an OAM component 198, which may configure a UE to perform operations 1400 of FIG. 14 and/or operations 1500 of FIG. 15. Wireless communication network 100 includes an OAM component 199, which may configure a network entity (e.g., a base station, such as a gNB) to perform operations 1400 of FIG. 14 and/or operations 1500 of FIG. 15.

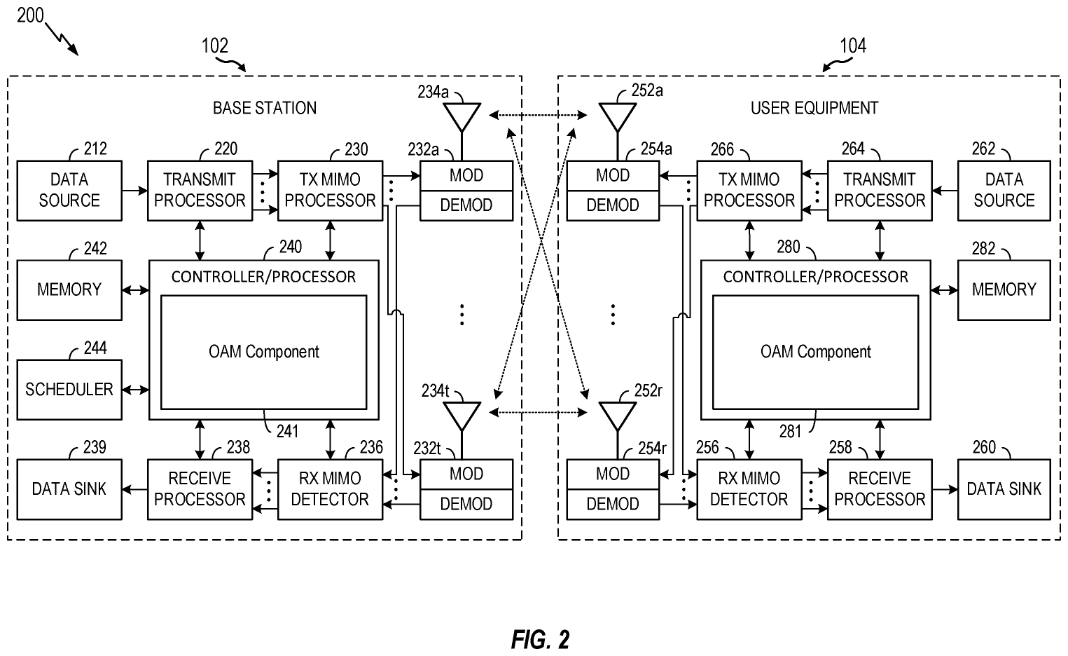

FIG. 2 depicts aspects of an example base station (BS) 102 and a user equipment (UE) 104.

Generally, base station 102 includes various processors (e.g., 220, 230, 238, and 240), antennas 234a-t (collectively antennas 234), transceivers 232a-t (collectively transceivers 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes an OAM component 241, which may be representative of OAM component 199 of FIG. 1. Notably, while depicted as an aspect of controller/processor 240, an OAM component 241 may be implemented additionally or alternatively in various other aspects of base station 102 in other implementations.

Generally, user equipment 104 includes various processors (e.g., 258, 264, 266, and 280), antennas 252a-r (collectively antennas 252), transceivers 254a-r (collectively transceivers 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes OAM component 281, which may be representative of SL component 198 of FIG. 1. Notably, while depicted as an aspect of controller/processor 280, OAM component 281 may be implemented additionally or alternatively in various other aspects of user equipment 104 in other implementations.

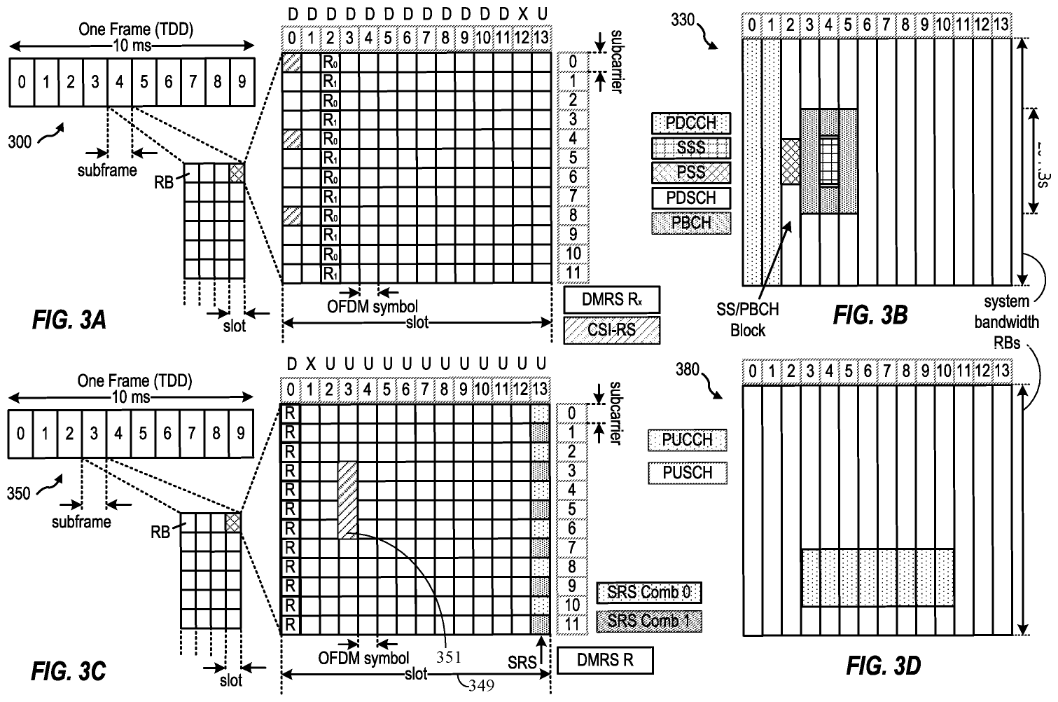

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe. In some aspects, UEs may be configured to communicate (e.g., via SL communications) using the frame format described with respect to diagrams 300, 330, 350, 380. A radio frame (e.g., as shown in diagram 300) may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS, during which SL communication may occur. Further discussions regarding FIG. 1, FIG. 2, and FIGS. 3A-3D are provided later in this disclosure.

As noted above, the techniques presented herein may be applied in various bands utilized for NR (5G) and future systems (e.g., 5G+, 6G, and beyond). For example, the higher band referred to as FR4 (e.g., 52.6 GHZ-114.25 GHZ), an OFDM waveform with very large subcarrier spacing (960 kHz-3.84 MHz) is required to combat severe phase noise. Due to the large subcarrier spacing, the slot length tends to be very short. In a lower band referred to as FR2 (24.25 GHz to 52.6 GHZ) with 120 kHz SCS, the slot length is 125 uSec, while in FR4 with 960 kHz, the slot length is 15.6 uSec. In some cases, a frequency band referred to as FR2x may be used. The techniques may also be applied in the FRI band (4.1 GHz to 7.125 GHZ), for example, may be used for channel state information (CSI) feedback, control messages, or on control plane signaling.

### Overview of OAM-Based Communications

Orbital angular momentum (OAM) refers to the component of angular momentum of a light beam that is dependent on the spatial distribution, rather than on the polarization. The OAM component can be visualized as a waveform with a helical phase. The OAM-based waveform has different modes (due to different topological charges), which are orthogonal to each other. As traditional resources (e.g., frequency, time, and space) are efficiently utilized, the orthogonality of different OAM modes may help address capacity and performance demands of current and future wireless networks.

OAM-based communication systems may perform well in short/middle-distance wireless communication, particularly at high frequency spectrum (e.g., sub-THz, THz). Examples of such scenarios include wireless backhaul transmissions (e.g., from a base station to relay node), fixed wireless access (e.g., from a base station to a UE or Customer Premises Equipment (CPE)), or inter-device transmission (e.g., from fixed UE to fixed UE or inter-server connections in a data center).

Communication based on OAM mode-division multiplexing (MDM), due to its capability to provide high-order spatial multiplexing, may be regarded as a potential technological enhancement for future systems (e.g., 5G+ or 6G and beyond systems) that aim to provide further higher data rate than current systems.

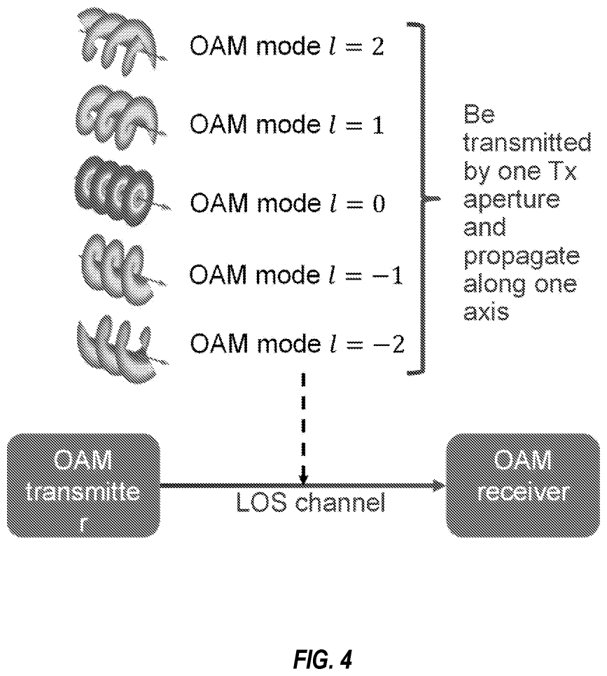

As illustrated in FIG. 4, in systems utilizing OAM multiplexing, an OAM transmitter radiates multiple coaxially propagating, spatially-overlapping waves (e.g., OAM model= . . . , −2, −1, 0, 1, 2, . . . ) each carrying a data stream through a pairs of apertures. As illustrated in FIG. 4, electro-magnetic (EM) waves with a helical transverse phase of the form exp(iφl) carry an OAM mode waveform, where φ is the azimuthal angle and l is an unbounded integer (referred as OAM order). Traditional EM beams (such as Gaussian beams) may be considered OAM beams with l=0.

Theoretically, these waves can be orthogonally received at the same radio (time-frequency domains) resource, and thus using OAM multiplexing can greatly improve communication spectrum efficiency with relatively low receiver (Rx) processing complexity. In some cases, polarization can be added to each OAM mode to double the number of orthogonal streams. Potential advantages of OAM based systems include high spatial multiplexing degree (particular in the line of site-LOS channel), resulting in a high data rate. In some cases, OAM base systems may utilize static Tx/Rx beamforming vector weights. As a result, there may be no need for inter-mode equalization at baseband (under direction alignment), which may result in relatively low baseband processing complexity.

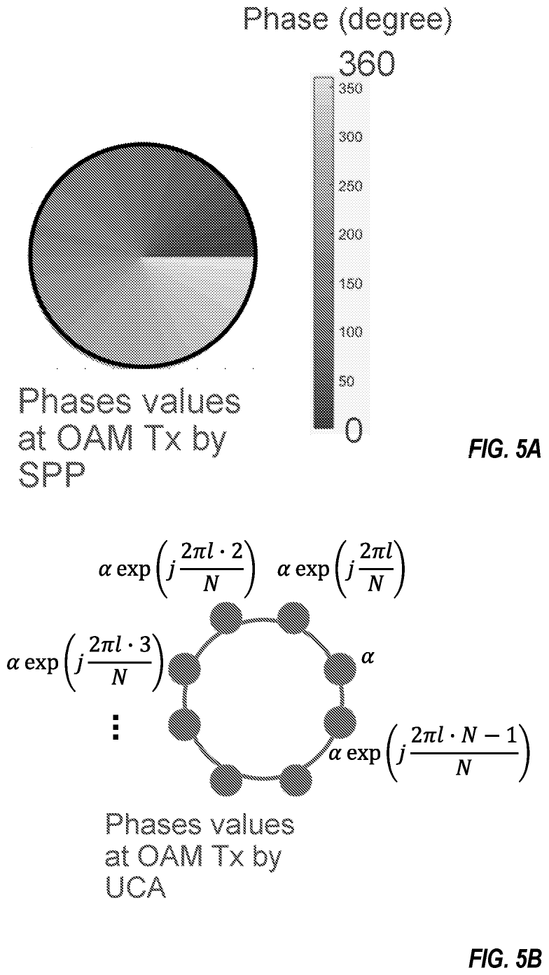

There are various options for implementing an OAM based communication systems. For example, one option may uses a number of transmitter apertures, transmitter spiral phase plates (SPPs), receiver SPPs and receiver apertures. FIG. 5A illustrates an example of phase values at an OAM transmitter, by SPP. In general, each transmitter aperture transmits the spiral wave of one OAM mode, modulated by the transmitter SPP. At the receive side, each receiver aperture receives the wave of one OAM mode (l=1 or l=−1), which is demodulated by the receiver SPP. Due to the mutual orthogonality among OAM modes, the wave of one OAM mode cannot be received by the receiver aperture of the other OAM mode. Further, utilization of SPP may requires the same number of SPPs as the multiplexed OAM modes, which may restrict the achievable multiplexing degree.

Another option, that may help realize abundant multiplexed modes in OAM communication with practical cost, is to implement an OAM based communication system using uniform circular array (UCA) transmitter (Tx) antennas and a set of UCA receiver antennas. As illustrated in FIG. 5B, a UCA antenna circle may be used at the transmit side to form phase-shifted received signal values at discrete element positions of a UCA antenna circle.

On the transmit side, the Tx antennas may be evenly equipped (e.g., with a uniform angular spacing) in a circle with a radius Rₜₓ. By multiplying respective OAM-formed weights w₁=[w_{1,1}, w_{1,2}, . . . , w_{1,8}]^{T} onto each antenna, a signal port may generated. If the weight of each antenna is equal to exp(iφl), where φ is the angle of antenna in the circle (e.g., relative to a horizontal axis drawn from an antenna at the center of the circle), l is the OAM mode index, then this OAM-formed port is equivalent OAM mode l. By using different OAM-formed weightsexp(iφl′), where l′≠l, multiple OAM modes are generated. In the illustrated example, NOAM modes are generated.

Similarly, on the receive-side, the OAM receiver also has UCA structure, with a number of Rx antennas evenly equipped (e.g., with a uniform angular spacing) in a circle with a radius Rᵣₓ. Assuming the channel matrix from each transmit antenna to each receive antenna as H, then for the OAM-formed channel matrix \tilde{H}=H·[w₁, w₂, . . . , w_{L}], any two columns of \tilde{H} are orthogonal. This generally means that all the OAM channels will have no crosstalk. This is the reason why OAM-based communication can efficiently realize a relatively high-level spatial multiplexing degree. In general, the center antenna of all UCA structure circles can be used alone to generate OAM mode 0.

Various parameters may impact the performance of OAM-based communications systems. For example, in general, a larger radius (for Rₜₓ and Rᵣₓ) results in a higher OAM multiplexing degree and a higher collective throughput (of streams on all modes). Similarly, higher frequency typically results in higher OAM multiplexing degree, but with a lower collective throughput. Depending on the (radius/frequency settings), a relatively high number (e.g., multiples of tens) of OAM modes may be used.

Various factors may be considered when choosing between UCA and SPP to transmit multiple orthogonal signals with different OAM modes. SPP-based OAM generates continuous spiral waves and, thus, can form unlimited numbers of orthogonal OAM modes in theory. In practice, however, due to propagation divergence and one mode per SPP, the number of effective OAM modes is typically limited.

UCA-based OAM generates a discrete spiral wave and, thus, can form OAM modes at most with the same number as Tx antennas. UCA-based OAM effectively belongs to multiple-input multiple-output (MIMO) whose Eigen-based Tx precoding weights and Rx combining weights are constantly equal to a DFT matrix, which is generally independent of communication parameters (such as distance, aperture size and carrier frequency) and, thus, may be implemented at relatively low cost.

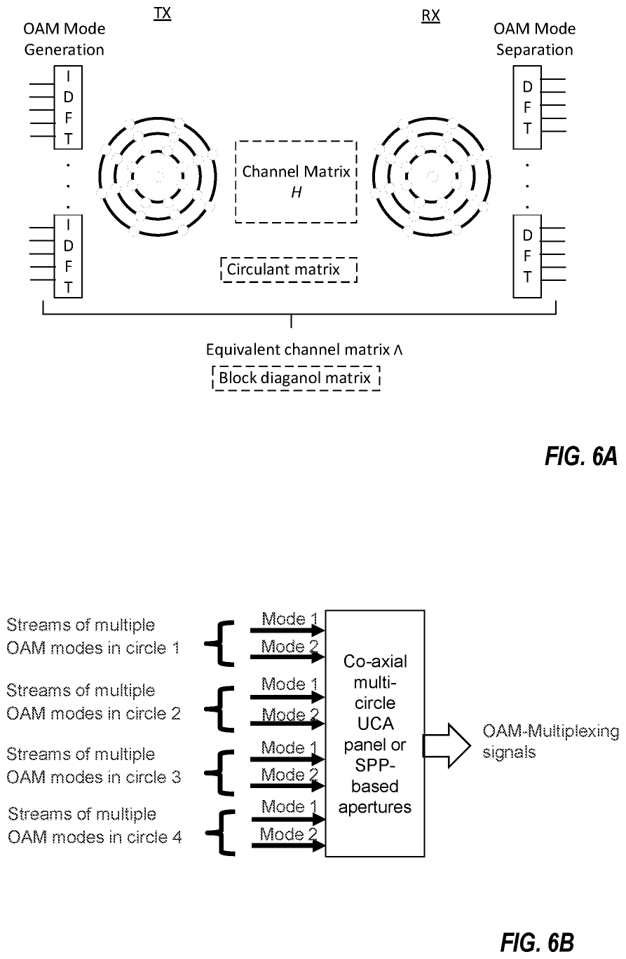

FIG. 6A illustrates an example multi-circle OAM-based communication system. As illustrated, multiple circles (deployed at both transmitter and receiver) may be formed, for example, of multiple co-axis UCA antenna circles or multiple circles of SPP-based apertures. As illustrated in FIG. 6B, the intra-circle streams are generally orthogonal. The inter-circle streams, on the other hand, are generally orthogonal with different OAM modes, but non-orthogonal with the same OAM mode.

Example Configurable Antenna Resources for Backhaul and Access with UCA Panel

Aspects of the present disclosure provide apparatuses, methods, processing systems, and computer-readable mediums for wireless communications using configurable antenna resources for backhaul and access with a uniform circular array (UCA) panel.

As noted above, advanced Networks (5G+, 6G), such as the example network 700 shown in FIG. 7, may rely on relatively densely deployed IAB nodes to help meet demanding data requirements. As illustrated, IAB nodes may provide backhaul support between network entities, such as other IAB nodes and customer premise equipment CPE), as well as access support to user equipments (UEs).

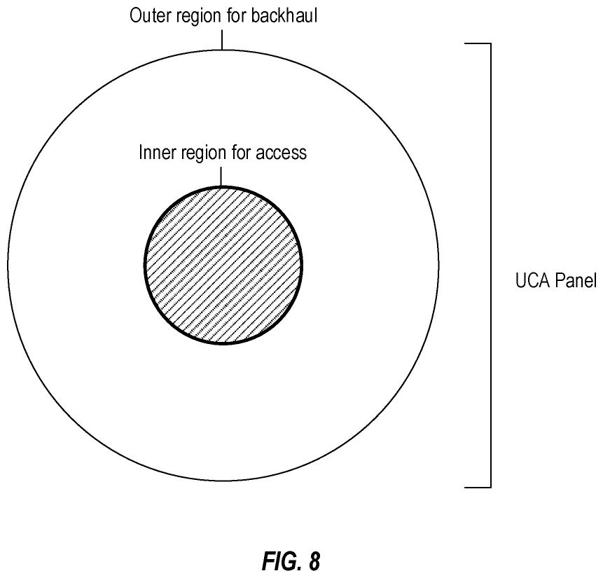

In some cases, as illustrated in FIG. 8, an IAB node may use outer antenna rings of a uniform circular array (UCA) panel to transmit backhaul traffic and inner antenna rings to transmit access traffic. Because a UE does not often lie in the boresight direction of network entity (e.g., gNB/IAB node) UCA panel, non-OAM beams may be used for the access link, such as the beams with exponential cosine series:

$${w}_{θ , φ} = \frac{1}{\sqrt{N}} {[ {e}^{j \frac{2 π r}{λ} sin θ cos ( φ - {φ}_{0} )} , {e}^{j \frac{2 π r}{λ} sin θ cos ( φ - \frac{2 π}{N} - {φ}_{0} )} , … , {e}^{j \frac{2 π r}{λ} sin θ cos ( φ - \frac{2 π ( N - 1 )}{N} - {φ}_{0} )} ]}^{T}$$

as weights.

Aspects of the present disclosure provide mechanisms that may help address changing traffic needs of backhaul and access links by providing mechanisms where a wireless node may use a first portion of a UCA panel for backhaul traffic and a second portion for access traffic. For example, in an IAB system with a UCA panel, an IAB node may simultaneously act as a gNB to transmit access traffic to a UE from inner antenna rings, and act as an over the air management (OAM) transmitter to transmit backhaul traffic to its child IAB node from outer antenna rings.

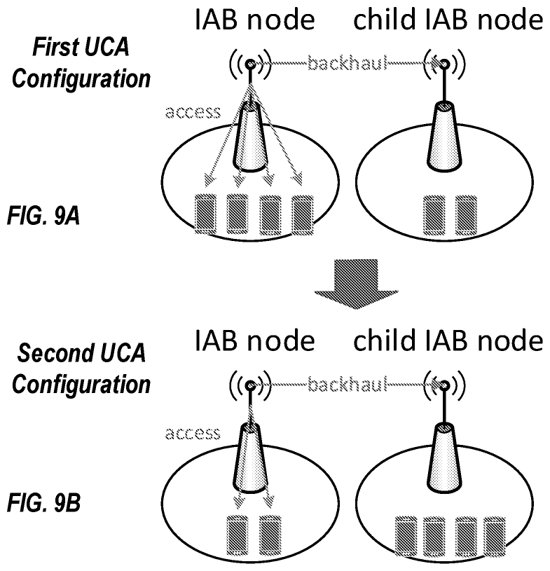

For example, the mechanisms described herein may allow a first UCA antenna ring configuration when more UEs are served by the access link of a parent IAB node than a child IAB node, as shown in FIG. 9A. As illustrated in FIG. 9B, a second UCA antenna ring configuration may be used when some of the UEs move from the cell of the parent IAB node to the cell of the child IAB node, resulting in an increase in backhaul traffic and decrease in access traffic (from the parent IAB node perspective).

In some cases, the parent IAB node may signal the child IAB node an indication of the UCA configurations (e.g., initial configurations and reconfigurations). For example, in the backhaul link, the IAB node may indicate per-OAM-mode transmit (Tx) antenna rings in the outer region and middle region of the UCA panel. In some cases, the indication may be expressed as the smallest Tx antenna ring for each OAM mode. For the access link, the parent IAB node (acting as a gNB) may indicate a per-CSI-RS-resource (or port) for Tx antenna rings in the inner region and middle region of the UCA panel. In this case, the indication format may be the largest Tx antenna ring for each CSI-RS resource/port.

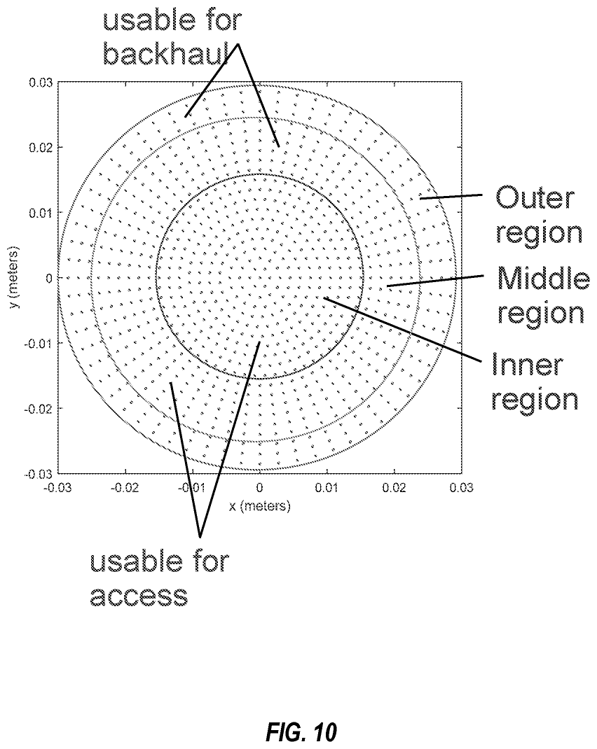

FIG. 10 illustrates an example of how hardware resources, UCA panel antenna rings, may be divided into regions used for different purposes. In the illustrated example, the antennas in the UCA panel are placed in a number of co-centric rings, which may be divided into three regions: an outer region, middle region, and inner region. Of course more complicated partitions may also be used (e.g., with multiple middle regions and/or with one or more of the regions being partitioned further).

As illustrated, in the outer region, the antenna rings have the same number of antenna elements. Therein, the antenna spacing are different at different rings. As noted above, these rings may be used primarily for backhaul traffic.

In the inner region, the antenna elements in the rings may have (approximately) uniform antenna spacing (e.g., half wavelength). Thus, the number of antenna elements are different at different rings. For example, the number of antennas in each ring may be equal to

$$⌊ \frac{2 π r}{\frac{λ}{2}} ⌋ ,$$

where r is the ring radius, λ is wavelength. These antenna rings may be used primarily for access.

In the middle region, the antenna rings may also have the same number of antenna elements. These rings may be used for both backhaul and access. In some cases, reconfiguration of the allocation between backhaul and access may entail effectively moving the border between the middle region and the inner and/or outer regions. It may be noted that, in some use cases, the configuration may result in effectively no outer region, such that all rings are usable for access.

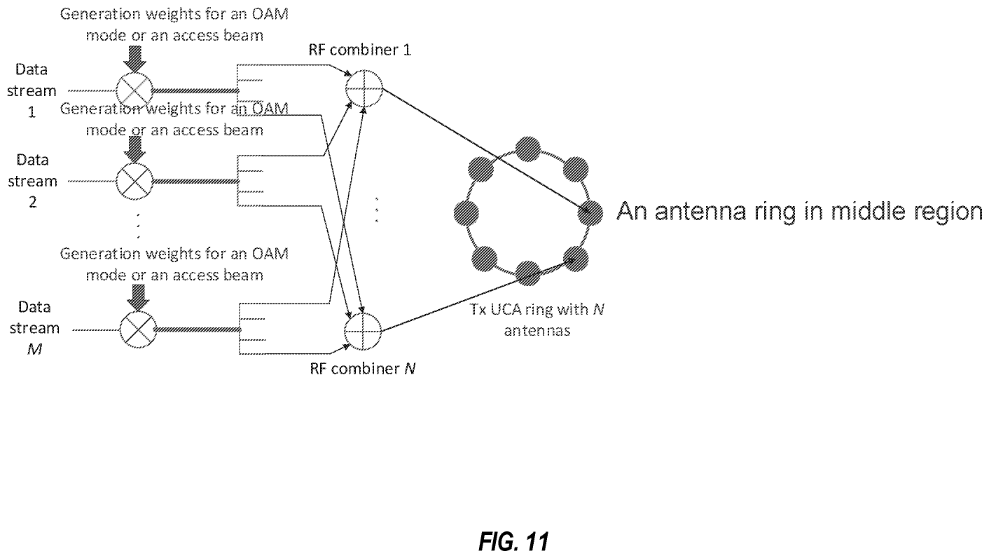

In some cases, one or more of the antenna rings may be connected to multiple RF chains, as illustrated in FIG. 11. In such cases, these RF chains can be used to transmit some backhaul streams (with different OAM modes in outer or middle region), some access streams (with different access beams in inner or middle region), or some backhaul streams and some access streams (with different OAM modes and different access beams in middle region). In some cases, for a Tx ring, partial RF chains are used for backhaul and partial RF chains are used for access.

As noted above, for a backhaul link, an OAM transmitter (e.g., a parent IAB node) may initially configure a set of UCA Tx antenna rings for the OAM receiver (e.g., a child IAB node). There are various options for how the antenna rings may be configured (or reconfigured) and how the configuration (or reconfiguration) is communicated.

For example, according to a first option, all OAM modes may use the same set of Tx antenna rings. According to a second option, each OAM mode may use a different set of Tx antenna rings. This option may make sense because different OAM modes have different suitable Tx ring radiuses. For example, OAM mode 1 can achieve high channel gain using Tx ring 5 or Tx ring 6, while OAM mode 2 may achieve higher channel gain using Tx ring 7 or Tx ring 8.

Typically, each OAM mode is associated with one CSI-RS resource. This CSI-RS resource may have multiple ports, each of which may be associated with one Tx antenna ring. An OAM mode order may be configured for each CSI-RS resource.

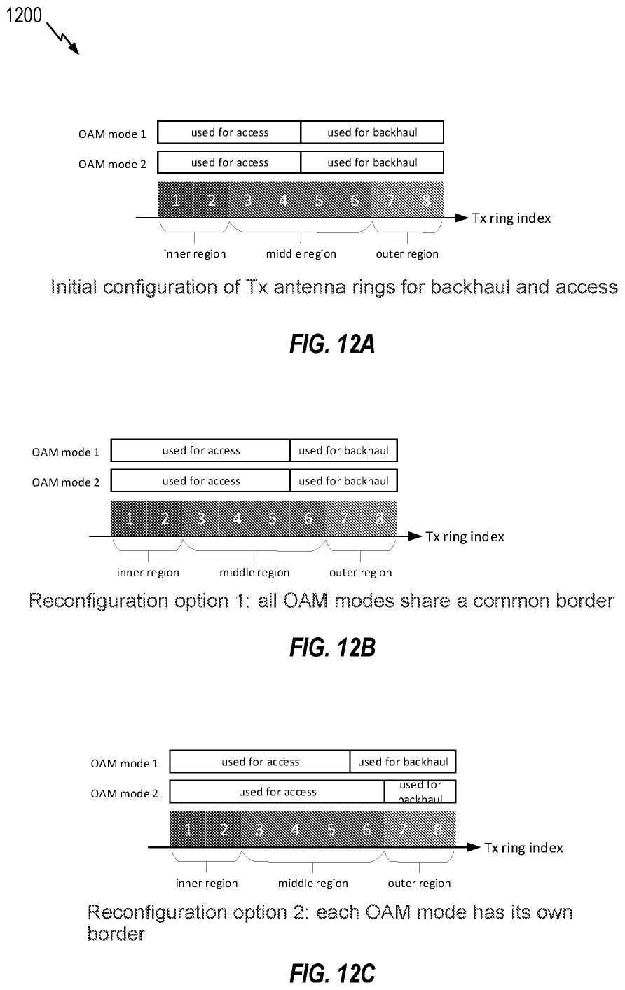

As noted above, and shown in FIG. 10, Tx antenna rings for backhaul traffic may lie in the outer region or the middle region. In some cases, these Tx antenna rings may be indexed based on their positions from inner to outer or from outer to inner. For example, FIGS. 12A-12C illustrate an example where Tx antenna rings are indexed 1-8 from inner to outer (e.g., meaning index 1 is the inner-most antenna ring, while index 8 is the outer-most antenna ring).

As noted above, the OAM transmitter (e.g., parent IAB node) may initially configure the antenna ring borders between (antenna rings used for) backhaul (antenna rings used for) and access.

FIG. 12A illustrates an example of an initial configuration where antenna rings 1-4, including two inner region antenna rings 1-2 and two middle region antenna rings 3-4, are configured for access traffic while antenna rings 5-8, including two middle region antenna rings 5-6 and two outer region antenna rings 7-8 are configured for backhaul traffic.

Based on the backhaul/access traffic change, the OAM transmitter (e.g., parent IAB node) may reconfigure the antenna ring borders. This reconfiguration may be seen as substantially equivalent to the activation/deactivation of Tx antenna rings) for each OAM mode.

There are various options for how to configure and reconfigure borders between antenna rings and signal corresponding information (e.g., to a child IAB node on the backhaul). According to a first option, all OAM modes share a common border. In other words, any reconfiguration results in the same allocation of antenna rings between access and backhaul for all OAM modes. FIG. 12B illustrates an example reconfiguration according to this option, where the access traffic gains one antenna ring and the backhaul traffic loses one antenna ring. As illustrated, after reconfiguration, antenna rings 1-5 are configured for access traffic while antenna rings 6-8 are configured for backhaul traffic, with the same allocation for both OAM modes 1 and 2.

According to a second option, each OAM mode may have its own border. FIG. 12C illustrates an example reconfiguration according to this option, where OAM modes 1 and 2 have separate borders. Relative to the initial configuration of FIG. 12A, OAM mode 1 gains one antenna ring for access traffic and loses one antenna ring for backhaul traffic, while OAM mode 2 gains two antenna rings for access traffic and loses two antenna rings for backhaul traffic.

In some cases, to indicate the new border (common to all OAM modes or OAM mode specific), the OAM transmitter can indicate the smallest Tx antenna ring that is outside the border. Regarding signaling overhead, this indication may consume [log₂ N_{middle}] bits, where N_{middle} is the number of antenna rings in the middle region.

With this information, the OAM receiver (e.g., child IAB node) can know the Tx antenna configuration. Based on this, the OAM receiver can select suitable Tx antenna rings or determine inter-ring precoding weight for each OAM mode, and then report the selection/determination result to OAM transmitter.

Some UEs (e.g., relatively high-end UEs) may be able to perform channel estimation by estimating the non-beamformed channel matrix. With high frequency spectrum, the CSI-RS may be beamformed by an analog beam. A lower-end UE typically only estimates the beamformed channel gain under a given beamforming weight. However, this given beamforming weight may not perfectly point to this UE and, thus, some beamforming gain loss may be caused.

To improve the beamforming gain, some high-end UE with higher processing capability can estimate the non-beamformed channel matrix based on the beamformed CSI-RS and some algorithms. Such algorithms may involve, for example, compressive sensing and/or machine learning. After estimation, the UE may report a (relatively perfect) beamforming weight vector to the gNB. To help enable this, an OAM transmitter serving as a gNB may provide the UE with information regarding the Tx antennas.

These high-end UEs can typically be distinguished from other (lower end) UEs by the gNB (IAB node) based on a UE capability report. Once identified, the IAB node may indicate antenna ring configuration/reconfiguration information.

To support these high-end UEs, the gNB (IAB node) may initially signal them an indication of configuration information for antenna resources for each CSI-RS resource or port. In some cases, this configuration information may include one or more of: the number of antenna rings, the radius of each ring, the number of antenna elements at each ring, and/or the number of maximum ports (RF chains) used for this CSI-RS resource or port at each ring.

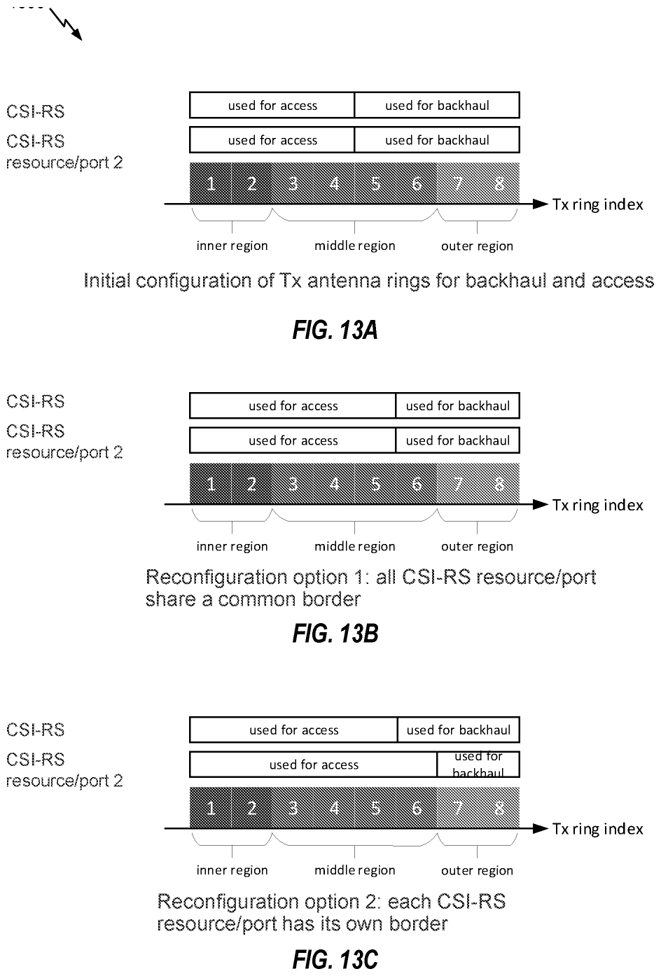

FIG. 13A shows an example of an initial configuration for each CSI-RS RS resource (port) where, like the initial configuration shown in FIG. 12A, antenna rings 1-4 are configured for access traffic while antenna rings 5-8 are configured for backhaul traffic, with each CSI-RS resource (port) having the same allocation.

Based on backhaul/access traffic change, the gNB (IAB node) may indicate the reconfiguration of antenna resource for each CSI-RS resource or port to the UE. There are various options for how to reconfigure borders between antenna rings for different CSI-RS resources (ports). As illustrated in FIG. 13B, according to a first option, all CSI-RS resources (ports) may share a common border. As illustrated in FIG. 13C, according to a second option, each CSI-RS resource (port) may have its own border.

Since the Tx antenna rings in the inner region are fixed for access, only the changes on middle region needs to be indicated. In reconfiguration message, the border between backhaul and access may be indicated for each CSI-RS resource or port, which can be expressed by the index of the largest Tx antenna ring inner than the border.

As described herein, aspects of the present disclosure provide mechanisms for configuration and reconfiguration of UCA Tx antenna resources (e.g., in unit of antenna rings) between backhaul and access traffic. The mechanisms provided herein provide flexibility to adapt to changes in backhaul and access traffic (e.g., due to UE mobility) and may help reduce deployment cost and improve hardware utilization ratio.

### Example Methods

FIGS. 14 and 15 are flow diagrams illustrating operations 1400 and 1500 from the perspective of a first wireless node (e.g., the parent IAB node shown in FIG. 9B) and a second wireless node (e.g., the child IAB node shown in FIG. 9B), respectively.

Referring first to FIG. 14, the operations 1400 may be performed, for example, by a first wireless node (e.g., a UE 104 or BS 102 in the wireless communication network 100 acting as a parent IAB). The operations 1400 may be implemented as software components that are executed and run on one or more processors (e.g., controller/processor 240 and/or 280 of FIG. 2). Further, the transmission of signals by the transmitter in operations 1400 may be enabled, for example, by one or more antennas (e.g., antennas 252 and/or 234 of FIG. 2). In certain aspects, the transmission of signals by the transmitter may be implemented via a bus interface of one or more processors (e.g., controller/processor 240 and/or 280) outputting signals.

The operations 1400 begin, at 1410, by transmitting traffic to a user equipment (UE) on an access link, using a first portion of a uniform circular array (UCA) antenna panel. At 1420, the first wireless node transmits traffic to a second wireless node on a backhaul link, using a second portion of the UCA antenna panel.

Referring first to FIG. 15, the operations 1500 are operations that may be considered complementary to the transmitter-side operations 1400. For example, operations 1500 may be performed by a second wireless node (e.g., a UE 104 or BS 102 in the wireless communication network 100 acting as a child IAB node) to receive and process signaling sent, on a backhaul link, from a transmitter performing operations 1500 of FIG. 15. Operations 1500 may be implemented as software components that are executed and run on one or more processors (e.g., controller/processor 240 and/or 280 of FIG. 2). Further, the reception of signals by the receiver in operations 1500 may be enabled, for example, by one or more antennas (e.g., antennas 252 and/or 234 of FIG. 2). In certain aspects, the reception of signals by the receiver may be implemented via a bus interface of one or more processors (e.g., controller/processor 240 and/or 280) obtaining signals.

The operations 1500 begin, at 1510, by receiving, from a first wireless node, an indication of a configuration of a first portion of a uniform circular array (UCA) antenna panel to use for communication with the first wireless node on a backhaul link. At 1520, the second wireless node receives traffic from the first wireless node on the backhaul link, using the first portion of the UCA antenna panel.

### Example Wireless Communication Devices

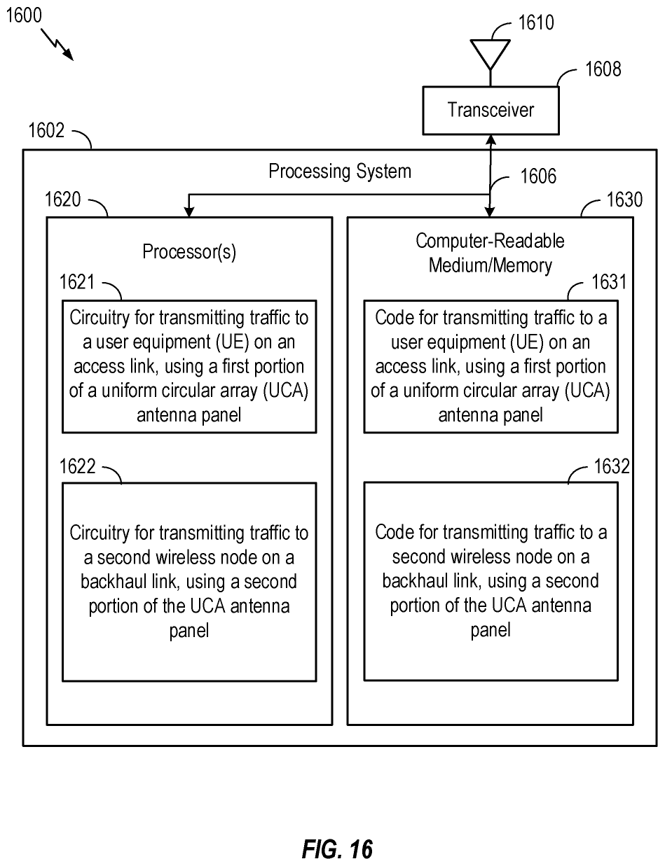

FIG. 16 depicts an example communications device 1600 that includes various components operable, configured, or adapted to perform operations for the techniques disclosed herein, such as the operations depicted and described with respect to FIG. 14. In some examples, communication device 1600 may be a user equipment 104 or BS 102 as described, for example with respect to FIGS. 1 and 2.

Communications device 1600 includes a processing system 1602 coupled to a transceiver 1608 (e.g., a transmitter and/or a receiver). Transceiver 1608 is configured to transmit (or send) and receive signals for the communications device 1600 via an antenna 1610, such as the various signals as described herein. Processing system 1602 may be configured to perform processing functions for communications device 1600, including processing signals received and/or to be transmitted by communications device 1600.

Processing system 1602 includes one or more processors 1620 coupled to a computer-readable medium/memory 1630 via a bus 1606. In certain aspects, computer-readable medium/memory 1630 is configured to store instructions (e.g., computer-executable code) that when executed by the one or more processors 1620, cause the one or more processors 1620 to perform the operations illustrated in FIG. 14.

In the depicted example, computer-readable medium/memory 1630 stores code 1631 (e.g., an example of means for) for transmitting traffic to a user equipment (UE) on an access link, using a first portion of a uniform circular array (UCA) antenna panel; and code 1632 (e.g., an example of means for) for transmitting traffic to a second wireless node on a backhaul link, using a second portion of the UCA antenna panel.

In the depicted example, the one or more processors 1620 include circuitry configured to implement the code stored in the computer-readable medium/memory 1630, including circuitry 1621 (e.g., an example of means for) for transmitting traffic to a user equipment (UE) on an access link, using a first portion of a uniform circular array (UCA) antenna panel; and circuitry 1622 (e.g., an example of means for) for transmitting traffic to a second wireless node on a backhaul link, using a second portion of the UCA antenna panel.

Various components of communications device 1200 may provide means for performing the methods described herein, including with respect to FIG. 14.

In some examples, means for transmitting or sending (or means for outputting for transmission) may include the transceivers 254 and/or antenna(s) 252 of the user equipment 104 illustrated in FIG. 2 and/or transceiver 1608 and antenna 1610 of the communication device 1600 in FIG. 16.

Notably, FIG. 16 is just use example, and many other examples and configurations of communication device 1600 are possible.

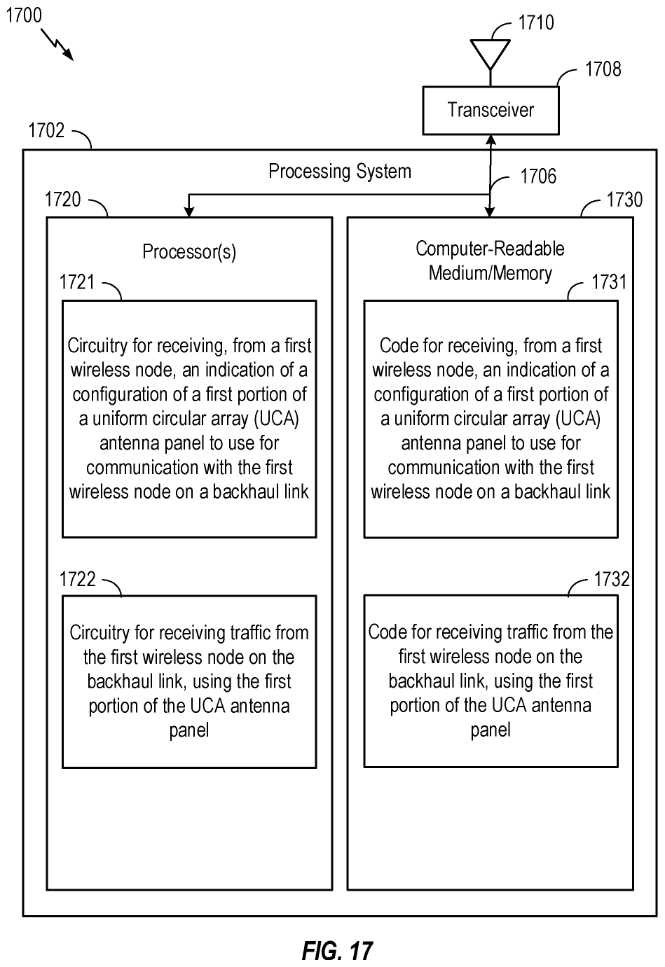

FIG. 17 depicts an example communications device 1700 that includes various components operable, configured, or adapted to perform operations for the techniques disclosed herein, such as the operations depicted and described with respect to FIG. 15. In some examples, communication device 1700 may be a user equipment 104 or BS 102 as described, for example with respect to FIGS. 1 and 2.

Communications device 1700 includes a processing system 1702 coupled to a transceiver 1708 (e.g., a transmitter and/or a receiver). Transceiver 1708 is configured to transmit (or send) and receive signals for the communications device 1700 via an antenna 1710, such as the various signals as described herein. Processing system 1702 may be configured to perform processing functions for communications device 1700, including processing signals received and/or to be transmitted by communications device 1700.

Processing system 1702 includes one or more processors 1720 coupled to a computer-readable medium/memory 1730 via a bus 1706. In certain aspects, computer-readable medium/memory 1730 is configured to store instructions (e.g., computer-executable code) that when executed by the one or more processors 1720, cause the one or more processors 1720 to perform the operations illustrated in FIG. 15.

In the depicted example, computer-readable medium/memory 1730 stores code 1731 (e.g., an example of means for) for receiving, from a first wireless node, an indication of a configuration of a first portion of a uniform circular array (UCA) antenna panel to use for communication with the first wireless node on a backhaul link; and code 1732 (e.g., an example of means for) for receiving traffic from the first wireless node on the backhaul link, using the first portion of the UCA antenna panel.

In the depicted example, the one or more processors 1720 include circuitry configured to implement the code stored in the computer-readable medium/memory 1730, including circuitry 1721 (e.g., an example of means for) for receiving, from a first wireless node, an indication of a configuration of a first portion of a uniform circular array (UCA) antenna panel to use for communication with the first wireless node on a backhaul link; and circuitry 1722 (e.g., an example of means for) for receiving traffic from the first wireless node on the backhaul link, using the first portion of the UCA antenna panel.

Various components of communications device 1700 may provide means for performing the methods described herein, including with respect to FIG. 15.

In some examples, means for receiving (or means for obtaining) may include the transceivers 254 and/or antenna(s) 252 of the user equipment 104 illustrated in FIG. 2 and/or transceiver 1708 and antenna 1710 of the communication device 1700 in FIG. 17.

Notably, FIG. 17 is just use example, and many other examples and configurations of communication device 1700 are possible.

### Example Clauses

Implementation examples are described in the following numbered clauses:

Clause 1: A method for wireless communications by a first wireless node, comprising transmitting traffic to a user equipment (UE) on an access link, using a first portion of a uniform circular array (UCA) antenna panel, and transmitting traffic to a second wireless node on a backhaul link, using a second portion of the UCA antenna panel.

Clause 2: The method of clause 1, wherein the first wireless node comprises an Integrated Access and Backhaul (IAB) node and the second wireless node comprises a child IAB node of the first wireless node.

Clause 3: The method of any one of clauses 1 and 2, wherein the first wireless node transmits with an orbital angular momentum (OAM) mode when transmitting traffic to the second wireless node on the backhaul link.

Clause 4: The method of clause 3, wherein the first portion of the UCA panel comprises a first number of antenna rings in an inner region and a middle region of the UCA antenna panel, and the second portion of the UCA panel comprises a second number of antenna rings in an outer region and a middle region of the UCA antenna panel.

Clause 5: The method of clause 4, wherein the first wireless node indicates the first number of antenna rings, to the second wireless node, as a largest antenna ring for each channel state information reference signal (CSI-RS) resource or CSI-RS port.

Clause 6: The method of any one of clauses 4 and 5, wherein the first wireless node indicates the second number of antenna rings, to the second wireless node, per OAM mode, as a smallest antenna ring for each OAM mode.

Clause 7: The method of any one of clauses 4 through 6, wherein antenna rings in the outer region have a same number of antenna elements, with different spacings between antenna elements at different rings, antenna rings in the middle region have a same number of antenna elements, with different spacings between antenna elements at different rings, and antenna rings in the inner region have substantially uniform antenna spacing.

Clause 8: The method of any one of clauses 4 through 7, wherein at least one antenna ring of the UCA antenna panel is connected to multiple RF chains.

Clause 9: The method of clause 8, wherein the RF chains are used to transmit one or more backhaul streams with different OAM modes in the outer or middle region.

Clause 10: The method of any one of clauses 8 and 9, wherein the RF chains are used to transmit one or more access streams with different access beams in the inner or middle region.

Clause 11: The method of any one of clauses 8 through 10, wherein the RF chains are used to transmit one or more backhaul streams and one or more access streams with different OAM modes and different access beams in the middle region.

Clause 12: The method of any one of clauses 4 through 11, comprising configuring a set of the antenna rings for an OAM receiver, and transmitting an indication of the configuration to the second wireless node.

Clause 13: The method of clause 12, wherein all OAM modes use the same set of antenna rings.

Clause 14: The method of any one of clauses 12 and 13, wherein different OAM modes use different sets of antenna rings.

Clause 15: The method of one of clauses 12 through 14, wherein each OAM mode is associated with a channel state information reference signal (CSI-RS resource) with multiple ports, and each of the multiple ports is associated with an antenna ring.

Clause 16: The method of one of clauses 4 through 15, further comprising reconfiguring at least one antenna ring border between a first set of antenna rings used for backhaul and a first set of antenna rings used for access.

Clause 17: The method of clause 16, wherein all OAM modes share a common antenna ring border.

Clause 18: The method of one of clauses 16 and 17, wherein each OAM mode has its own antenna ring border.

Clause 19: The method of any one of clauses 16 through 18, further comprising indicating, to the second wireless node, the antenna ring border as a smallest antenna ring outside the antenna ring border.

Clause 20: The method of clause 19, further comprising receiving, from the second wireless node, an indication of suitable antenna rings or inter-ring precoding weights selected based on the indication.

Clause 21: The method of any one of clauses 4 through 20, further comprising indicating, to the UE, a configuration of antenna resources for each channel state information reference signal (CSI-RS) resource or port.

Clause 22: The method of clause 21, wherein the configuration includes at least one of: a number of antenna rings, a radius of each ring, a number of antenna elements at each ring, or a number of maximum ports used for this CSI-RS resource or port at each ring.

Clause 23: The method of any one of clauses 16 through 22, wherein the reconfiguration is based on a traffic change to at least one of backhaul traffic or access traffic.

Clause 24: The method of clause 23, wherein a change associated with the reconfiguration is indicated as a change to the middle region.

Clause 25: The method of clause 24, wherein the change is indicated as a largest antenna ring inside the antenna ring border.

Clause 26: A method for wireless communications by a second wireless node, comprising receiving, from a first wireless node, an indication of a configuration of a first portion of a uniform circular array (UCA) antenna panel to use for communication with the first wireless node on a backhaul link, and receiving traffic from the first wireless node on the backhaul link, using the first portion of the UCA antenna panel.

Clause 27: The method of clause 26, wherein the second wireless node comprises an Integrated Access and Backhaul (IAB) node and the first wireless node comprises a child IAB node of the first wireless node.

Clause 28: The method of any one of clauses 26 and 27, wherein the second wireless node receives with an orbital angular momentum (OAM) mode when receiving traffic from the first wireless node on the backhaul link.

Clause 29: The method of clause 28, wherein the second portion of the UCA panel comprises a first number of antenna rings in an inner region and a middle region of the UCA antenna panel, and the first portion of the UCA panel comprises a second number of antenna rings in an outer region and a middle region of the UCA antenna panel.

Clause 30: The method of clause 29, wherein the first wireless node indicates the first number of antenna rings as a largest antenna ring for each channel state information reference signal (CSI-RS) resource or CSI-RS port.

Clause 31: The method of any one of clauses 29 and 30, wherein the first wireless node indicates the second number of antenna rings, per OAM mode, as a smallest antenna ring for each OAM mode.

Clause 32: The method of any one of clauses 29 through 31, wherein antenna rings in the outer region have a same number of antenna elements, with different spacings between antenna elements at different rings, antenna rings in the middle region have a same number of antenna elements, with different spacings between antenna elements at different rings, and antenna rings in the inner region have substantially uniform antenna spacing.

Clause 33: The method of any one of clauses 29 through 32, wherein at least one antenna ring of the UCA antenna panel is connected to multiple RF chains.

Clause 34: The method of clause 33, wherein the RF chains are used to receive one or more backhaul streams with different OAM modes in the outer or middle region.

Clause 35: The method of any one of clauses 33 and 34, wherein the RF chains are used to receive one or more access streams with different access beams in the inner or middle region.

Clause 36: The method of any one of clauses 33 through 35, wherein the RF chains are used to receive one or more backhaul streams and one or more access streams with different OAM modes and different access beams in the middle region.

Clause 37: The method of any one of clauses 28 and 36, wherein the indication from the first wireless node configures the second wireless node with a set of the antenna rings for an OAM receiver.

Clause 38: The method of clause 37, wherein all OAM modes use the same set of antenna rings.

Clause 39: The method of any one of clauses 37 and 38, wherein different OAM modes use different sets of antenna rings.

Clause 40: The method of any one of clauses 37 through 39, wherein each OAM mode is associated with a channel state information reference signal (CSI-RS resource) with multiple ports, and each of the multiple ports is associated with an antenna ring.

Clause 41: The method of any one of clauses 28 through 40, further comprising receiving, from the first wireless node, an indication reconfiguring at least one antenna ring border between a first set of antenna rings used for backhaul and a first set of antenna rings used for access.

Clause 42: The method of clause 41, wherein all OAM modes share a common antenna ring border.

Clause 43: The method of any one of clauses 41 and 42, wherein each OAM mode has its own antenna ring border.

Clause 44: The method of any one of clauses 41 through 43, further comprising receiving, from the first wireless node, an indication of the antenna ring border as a smallest antenna ring outside the antenna ring border.

Clause 45: The method of clause 44 further comprising transmitting, to the first wireless node, an indication of suitable antenna rings or inter-ring precoding weights selected based on the indication.

Clause 46: The method of any one of clauses 28 through 45, further comprising indicating, to the UE, a configuration of antenna resources for each channel state information reference signal (CSI-RS) resource or port.

Clause 47: The method of any one of clauses 41 through 46, wherein the configuration includes at least one of: a number of antenna rings, a radius of each ring, a number of antenna elements at each ring, or a number of maximum ports used for this CSI-RS resource or port at each ring.

Clause 48: The method of any one of clauses 41 through 47, wherein the reconfiguration is based on a traffic change to at least one of backhaul traffic or access traffic.

Clause 49: The method of clause 48, wherein a change associated with the reconfiguration is indicated as a change to the middle region.

Clause 50: The method of clause 49, wherein the change is indicated as a largest antenna ring inside the antenna ring border.

Clause 51: A method for wireless communications by a user equipment (UE), comprising receiving, from a wireless node, a configuration of antenna resources for each of a plurality of channel state information reference signals (CSI-RS) resources or ports, estimating a non-beamformed channel matrix based on non-beamformed CSI-RS transmitted according to the configuration, and reporting a beamforming weight vector to the wireless node based on the estimation.

Clause 52: The method of clause 51, wherein the wireless node comprises an Integrated Access and Backhaul (IAB) node.

Clause 53: The method of any one of clauses 51 and 52, wherein the wireless node transmits the CSI-RS using a first portion of a uniform circular array (UCA) panel that comprises a first number of antenna rings at least in one of an inner region and a middle region of the UCA antenna panel.

Clause 54: The method of clause 53, wherein the configuration includes at least one of: a number of antenna rings, a radius of each ring, a number of antenna elements at each ring, or a number of maximum ports used for this CSI-RS resource or port at each ring.

Clause 55: An apparatus, comprising: a memory comprising executable instructions; one or more processors configured to execute the executable instructions and cause the apparatus to perform a method in accordance with any one of Clauses 1-54.

Clause 56: An apparatus, comprising means for performing a method in accordance with any one of Clauses 1-54.

Clause 57: A non-transitory computer-readable medium comprising executable instructions that, when executed by one or more processors of an apparatus, cause the apparatus to perform a method in accordance with any one of Clauses 1-54.

Clause 58: A computer program product embodied on a computer-readable storage medium comprising code for performing a method in accordance with any one of Clauses 1-54.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS or a home BS.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). Base stations 102 configured for 5G (e.g., 5G NR or Next Generation RAN (NG-RAN)) may interface with core network 190 through second backhaul links 184. Base stations 102 may communicate directly or indirectly (e.g., through the EPC 160 or core network 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mm Wave frequencies, the gNB 180 may be referred to as an mmWave base station. The gNB 180 may also communicate with one or more UEs 104 via a beam formed connection 182 (e.g., via beams 182′ and 182″).

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink (SL) channels, such as a physical SL broadcast channel (PSBCH), a physical SL discovery channel (PSDCH), a physical SL shared channel (PSSCH), and a physical SL control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

Core network 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and core network 190. Generally, AMF 192 provides QoS flow and session management.

All user Internet protocol (IP) packets are transferred through UPF 195, which is connected to the IP Services 197, and which provides UE IP address allocation as well as other functions for core network 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Transmit processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where Dis DL, Uis UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of NR and LTE sidelink co-channel co-existence in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications by a first wireless node, comprising:
transmitting traffic to a user equipment (UE) on an access link, using a first portion of a uniform circular array (UCA) antenna panel; and
transmitting traffic to a second wireless node on a backhaul link, using a second portion of the UCA antenna panel.

2. The method of claim 1, wherein the first wireless node comprises an Integrated Access and Backhaul (IAB) node and the second wireless node comprises a child IAB node of the first wireless node.

3. The method of claim 1, wherein the first wireless node transmits with an orbital angular momentum (OAM) mode when transmitting traffic to the second wireless node on the backhaul link.

4. The method of claim 3, wherein:
the first portion of the UCA panel comprises a first number of antenna rings in an inner region and a middle region of the UCA antenna panel; and
the second portion of the UCA panel comprises a second number of antenna rings in an outer region and a middle region of the UCA antenna panel.

5. The method of claim 4, wherein the first wireless node indicates the first number of antenna rings, to the second wireless node, as a largest antenna ring for each channel state information reference signal (CSI-RS) resource or CSI-RS port.

6. The method of claim 4, wherein the first wireless node indicates the second number of antenna rings, to the second wireless node, per OAM mode, as a smallest antenna ring for each OAM mode.

7. The method of claim 4, wherein:
antenna rings in the outer region have a same number of antenna elements, with different spacings between antenna elements at different rings;
antenna rings in the middle region have a same number of antenna elements, with different spacings between antenna elements at different rings; and
antenna rings in the inner region have substantially uniform antenna spacing.

8. The method of claim 4, wherein at least one antenna ring of the UCA antenna panel is connected to multiple RF chains.

9. The method of claim 8, wherein the RF chains are used to transmit one or more backhaul streams with different OAM modes in the outer region or middle region.

10. The method of claim 8, wherein the RF chains are used to transmit one or more access streams with different access beams in the inner region or middle region.

11. The method of claim 8, wherein the RF chains are used to transmit one or more backhaul streams and one or more access streams with different OAM modes and different access beams in the middle region.

12. The method of claim 4, comprising:
configuring a set of antenna rings for an OAM receiver; and
transmitting an indication of the configuration to the second wireless node.

13. The method of claim 12, wherein all OAM modes use a same set of antenna rings.

14. The method of claim 12, wherein different OAM modes use different sets of antenna rings.

15. The method of claim 12, wherein:
each OAM mode is associated with a channel state information reference signal (CSI-RS resource) with multiple ports; and
each of the multiple ports is associated with an antenna ring.

16. The method of claim 4, further comprising reconfiguring at least one antenna ring border between a first set of antenna rings used for backhaul and a first set of antenna rings used for access.

17. The method of claim 16, wherein all OAM modes share a common antenna ring border.

18. The method of claim 16, wherein each OAM mode has its own antenna ring border.

19. The method of claim 16, further comprising transmitting an indication, to the second wireless node, of the antenna ring border as a smallest antenna ring outside the antenna ring border.

20. The method of claim 19 further comprising receiving, from the second wireless node, an indication of suitable antenna rings or inter-ring precoding weights selected based on the indication.

21. The method of claim 4, further comprising indicating, to the UE, a configuration of antenna resources for each channel state information reference signal (CSI-RS) resource or port.

22. The method of claim 21, wherein the configuration includes at least one of: a number of antenna rings, a radius of each ring, a number of antenna elements at each ring, or a number of maximum ports used for this CSI-RS resource or port at each ring.

23. The method of claim 16, wherein the reconfiguring is based on a traffic change to at least one of backhaul traffic or access traffic.

24. The method of claim 23, wherein a change associated with the reconfiguring is indicated as a change to the middle region.

25. The method of claim 24, wherein the change is indicated as a largest antenna ring inside the antenna ring border.

26. A method for wireless communications by a second wireless node, comprising:
receiving, from a first wireless node, an indication of a configuration of a first portion of a uniform circular array (UCA) antenna panel to use for communication with the first wireless node on a backhaul link; and
receiving traffic from the first wireless node on the backhaul link, using the first portion of the UCA antenna panel.

27. A method for wireless communications by a user equipment (UE), comprising:
receiving, from a wireless node, a configuration of antenna resources for each of a plurality of channel state information reference signals (CSI-RS) resources or ports;
estimating a non-beamformed channel matrix based on non-beamformed CSI-RS transmitted according to the configuration; and
reporting a beamforming weight vector to the wireless node based on the estimation.

28. An apparatus for wireless communication by a user equipment (UE), comprising:
means for transmitting traffic to a user equipment (UE) on an access link, using a first portion of a uniform circular array (UCA) antenna panel; and
means for transmitting traffic to a second wireless node on a backhaul link, using a second portion of the UCA antenna panel.
